(19) United States
(12) Patent Application Publication
(10) Pub. No.: US 2019/0341012 A1
(43) Pub. Date: Nov. 7, 2019

(54) Resonance Signal Generating Method, Resonance Signal Generating Device, Electronic Musical Apparatus and Non-Transitory Computer Readable Medium

(71) Applicant: Yamaha Corporation, Hamamatsu-shi (JP)

(72) Inventors: Encai LIU, Hamamatsu-shi (JP); Masafumi NAKATA, Hamamatsu-shi (JP)

(21) Appl. No.: 16/514,127

(22) Filed: Jul. 17, 2019

Related U.S. Application Data
(63) Continuation of application No. PCT/JP2018/000615, filed on Jan. 12, 2018.

(30) Foreign Application Priority Data
Jan. 18, 2017 (JP) 2017-007119

(51) Int. Cl. G10H 1/08; G10K 15/12

(52) U.S. Cl. CPC G10H 1/08; G10H 2250/041; G10K 15/12

(57) ABSTRACT

A resonance signal generating method includes generating a first resonance signal of a specific pitch circulating through first loop processing by inputting an excitation signal to the first loop processing including first delay that delays the signal by a time corresponding to the specific pitch and first attenuation that attenuates the signal, generating a second resonance signal of the specific pitch circulating through second loop processing by the second loop processing including second delay that delays the signal by a time corresponding to the specific pitch and second attenuation that attenuates the signal, generating an attenuation change signal by adding the first resonance signal and the second resonance signal to each other, attenuating and inverting the added first and second resonance signals, and inputting the generated attenuation change signal to the first loop processing and the second loop processing respectively, and outputting the first resonance signal.

### BACKGROUND OF THE INVENTION

### Field of the Invention

The present invention relates to a resonance signal generating method and a resonance signal generating device for generating a resonance signal simulating resonance of a string based on an input excitation signal, an electronic musical apparatus including the resonance signal generating device, a non-transitory computer readable medium storing a program for allowing a computer to perform the resonance signal generating method.

### Description of Related Art

Conventionally, an attempt to electronically reproduce the sound generated by a natural musical instrument has been made by simulation of the behavior of the natural musical instrument.

As the technique in this field, JP 63-267999 A, for example, describes a technique for outputting a sound signal corresponding to a designated name of musical note (example C, D, E, F, G, A, B; Do, Re, Mi, Fa, Sol, La, Si) through a means for applying reverberation effects respectively having resonance peaks at a plurality of frequency positions respectively having the relationship of an integral multiplication with frequencies of pitches corresponding to a plurality of names of musical notes. By using the technique, a reverberation effect simulating a resonance effect caused by a plurality of sound-generating vibrators such as strings of a piano can be added to the sound signal, and the sound signal simulating the sound of the natural musical instrument can be generated.

Further, JP 2015-143763 A and JP 2015-143764 A describe a technique that enables the flexible setting of resonance frequencies by combining a delay time in a delay circuit in which a delay length can be set on a sample basis with an all-pass filter in which the delay length can be set more finely than on a sample basis in a resonance sound generation circuit that generates sound signals indicative of resonance sounds simulating sounds of strings of a piano.

### BRIEF SUMMARY OF THE INVENTION

The conventionally known circuit for simulating resonance sounds of strings is as follows.

That is, as shown in FIG. 11, the level of an excitation signal IN for exciting vibration of a string is adjusted by a level adjustor 501, and the adjusted excitation signal IN is input for each sample and delayed by a time corresponding to a resonance frequency of the string by a delayer 502. The delayed signal is attenuated by a predetermined gain value by an attenuator 503, the attenuated signal is added to the excitation signal of that time point by an adder 504, and the added signal is supplied to the delayer 502. Thereafter, loop processing is repeated by the delayer 502, the attenuator 503 and the adder 504 while an input of an excitation signal IN is received.

A delay amount of the delayer 502 is set such that one cycle of the above-mentioned loop processing is performed in the time of one period of the resonance frequency of the string. This enables generation of a sound signal simulating the resonance caused by a string having any resonance frequency in real time. That is, a component of the resonance frequency in the excitation signal IN is enhanced by addition of the delayed signal and the excitation signal IN of the next cycle to each other. Even after the level of the excitation signal IN has become zero, the sound signal circulates through a loop to be processed while being attenuated gradually by the attenuator 503. This sound signal is output from any position in the delayer 502 through the level adjustor 505 as a resonance signal OUT.

Here, as for the level of the resonance signal OUT after the level of the excitation signal IN becomes zero, when letting a gain of the attenuator 503 be FBG (FBG<1, FBG≈1), the level of the resonance signal OUT is simply exponentially attenuated in a manner in which the level is attenuated to FBG times in every one loop processing.

In the meantime, in a piano, which is a natural musical instrument, it is known that the level of a resonance sound is not simply exponentially attenuated when strings are not damped but attenuated in two stages including fast attenuation that is carried out right after a string hit and slow attenuation that is carried out after the fast attenuation. However, such two-stage attenuation cannot be easily reproduced with the above-mentioned conventional method. Thus, it is difficult to output a resonance sound sufficiently similar to the sound of the natural musical instrument.

An object of the present invention is to solve such a problem and enable generation of a signal of a resonance sound simulating level attenuation in two stages as in a piano with a small processing load. The piano is mentioned as one example of a musical instrument, and the present invention is applicable to generation of a resonance sound of a string in another musical instrument having a plurality of arranged strung strings.

In order to achieve the object described above, a resonance signal generating method according to one aspect of the present invention includes generating a first resonance signal of a specific pitch circulating through first loop processing by inputting an excitation signal to the first loop processing including first delay that delays the signal by a time corresponding to the specific pitch and first attenuation that attenuates the signal, generating a second resonance signal of the specific pitch circulating through second loop processing by the second loop processing including second delay that delays the signal by a time corresponding to the specific pitch and second attenuation that attenuates the signal, generating an attenuation change signal by adding the first resonance signal and the second resonance signal to each other, attenuating and inverting the added first and second resonance signals, and inputting the generated attenuation change signal to the first loop processing and the second loop processing, and outputting the first resonance signal.

In the embodiment, the generating the first resonance signal may include generating the first resonance signal circulating through the first loop processing by adding the signal attenuated by the first attenuation and the input excitation signal to each other, delaying the added signal by the first delay, adding the signal delayed by the first delay and the input attenuation change signal to each other, and attenuating the added signal by the first attenuation, and the generating the second resonance signal may include generating the second resonance signal circulating through the second loop processing by delaying the signal attenuated by the second attenuation by the second delay, adding the signal delayed by the second delay and the input attenuation change signal to each other, and attenuating the added signal by the second attenuation.

In the embodiment, a delay amount of the first delay may be set such that a time required for one circulation of the signal in the first loop processing is equal to one period of the specific pitch sound.

In the embodiment, the generating the first and second resonance signals may include generating a plurality of sets of the first and second resonance signals respectively by a plurality of sets of the first and second loop processing, and the plurality of sets of the first and second loop processing correspond to a plurality of the different specific pitches, the inputting the attenuation change signal may include generating attenuation change signals corresponding to specific pitches by adding to one another, attenuating and inverting the first and second resonance signals generated in each set of the first and second loop processing, and inputting a common attenuation change signal acquired by calculation of a plurality of the attenuation change signals corresponding to the plurality of specific pitches or a plurality of the attenuation change signals corresponding to the plurality of specific pitches, to the plurality of sets of the first and second loop processing respectively, and the outputting the first resonance signal may include adding the plurality of first resonance signals generated in the first loop processing of the plurality of sets to one another and outputting the first resonance signal acquired by addition.

In the embodiment, the specific pitch may include a predetermined number of different first specific pitches in a higher range and one or more second specific pitches in a lower range, the first and second loop processing may include the predetermined number of sets of the first and second loop processing corresponding to the predetermined number of first specific pitches and one or more first loop processing corresponding to the one or more second specific pitches, the generating the first and second resonance signals may include generating the first and second resonance signals in the predetermined number of sets by the predetermined number of sets of the first and second loop processing corresponding to the predetermined number of first specific pitches, and generating one or more first resonance signals by the one or more first loop processing corresponding to the one or more second specific pitches, the generating the attenuation change signal may include generating the predetermined number of attenuation change signals corresponding to the predetermined number of first specific pitches by adding the first and second resonance signals in each set corresponding to the predetermined number of first specific pitches to each other, attenuating and inverting the added first and second resonance signals, and generating one or more attenuation change signals corresponding to the one or more second specific pitches by attenuating and inverting the one or more first resonance signals corresponding to the one or more second specific pitches, and respectively inputting a common attenuation change signal acquired by calculation of the predetermined number of attenuation change signals corresponding to the predetermined number of first specific pitches and the one or more attenuation change signals corresponding to the one or more second specific pitches, or the predetermined number of attenuation change signals corresponding to the predetermined number of first specific pitches and the one or more attenuation change signals corresponding to the one or more second specific pitches, to the predetermined number of sets of the first and second loop processing corresponding to the predetermined number of first specific pitches and the one or more first loop processing corresponding to the one or more second specific pitches, and the outputting the first resonance signal may include adding the predetermined number of first resonance signals generated in the first loop processing of the predetermined number of sets corresponding to the predetermined number of first specific pitches and the one or more first resonance signals generated in the one or more first loop processing corresponding to the one or more second specific pitches to one another, and outputting the first resonance signal acquired by addition.

In the embodiment, the excitation signal may be a sound signal indicating musical performance of a piano, or a sound signal that is acquired by extraction of an attack from a sound signal indicating a musical performance sound of a piano.

In the embodiment, the resonance signal generating method may further include generating a sound signal indicating a musical performance sound of a predetermined tone color in response to a detected musical performance operation, supplying the generated sound signal to the first loop processing as the excitation signal, and adding the generated sound signal and the first resonance signal to each other and outputs the added signal.

A resonance signal generating device according to another aspect of the present invention include a first resonance signal generator that includes a first loop including a first delayer that delays a signal by a time corresponding to a specific pitch and a first attenuator that attenuates the signal, and an excitation inputter that inputs an excitation signal to the first loop, a second resonance signal generator that includes a second loop including a second delayer that delays the signal by a time corresponding to the specific pitch and a second attenuator that attenuates the signal, an inversion inputter that generates an attenuation change signal by adding a first resonance signal circulating through the first loop and a second resonance signal circulating through the second loop to each other, attenuating and inverting the added first and second resonance signals, and inputs the generated attenuation change signal to the first loop and the second loop, and an outputter that outputs the first resonance signal circulating through the first loop.

In the embodiment, the first resonance signal generator may generate the first resonance signal circulating through the first loop by adding the signal attenuated by the first attenuator and the input excitation signal to each other, delaying the added signal by the first delayer, adding the signal delayed by the first delayer and the input attenuation change signal to each other, and attenuating the added signal by the first attenuator, and the second resonance signal generator may generate the second resonance signal circulating through the second loop by delaying the signal attenuated by the second attenuator by the second delayer, adding the signal delayed by the second delayer and the input attenuation change signal to each other, and attenuating the added signal by the second attenuator.

In the embodiment, a delay amount of the first delayer may be set such that a time required for one circulation of the signal in the first loop is equal to one period of sound of the specific pitch.

In the embodiment, the first and second resonance signal generators may include a plurality of sets of the first and second resonance signal generators respectively corresponding to a plurality of the different specific pitches, and generate a plurality of sets of the first and second resonance signals respectively corresponding to the plurality of specific pitches, the inversion inputter may generate attenuation change signals corresponding to specific pitches by adding the first and second resonance signals generated in each set of the first and second loops to each other, attenuating and inverting the added first and second resonance signals, and inputting a common attenuation change signal acquired by calculation of attenuation change signals corresponding to the plurality of specific pitches or the plurality of attenuation change signals corresponding to the plurality of specific pitches to the plurality of sets of the first and second loops respectively, and the outputter may add the plurality of first resonance signals generated in the first loops of the plurality of sets and outputs the first resonance signal acquired by addition.

In the embodiment, the specific pitch may include a predetermined number of different first specific pitches from a highest sound and one or more second specific pitches from a lowest sound, the first and second resonance signal generators may include the predetermined number of sets of the first and second resonance signal generators respectively corresponding to the predetermined number of first specific pitches and one or more first resonance signal generators corresponding to the one or more second specific pitches, generate the first and second resonance signals in the predetermined number of sets corresponding to the predetermined number of first specific pitches, and generates one or more first resonance signals corresponding to the one or more second specific pitches, the inversion inputter may generate the predetermined number of attenuation change signals corresponding to the predetermined number of first specific pitches by adding the first and second resonance signals in each set corresponding to the predetermined number of first specific pitches to each other, attenuating and inverting the added first and second resonance signals, and generate one or more attenuation change signals corresponding to the one or more second specific pitches by attenuating and inverting the one or more first resonance signals corresponding to the one or more second specific pitches, and respectively input a common attenuation change signal acquired by calculation of the predetermined number of attenuation change signals corresponding to the predetermined number of first specific pitches and the one or more attenuation change signals corresponding to the one or more second specific pitches, or the predetermined number of attenuation change signals corresponding to the predetermined number of first specific pitches and the one or more attenuation change signals corresponding to the one or more second specific pitches, to the predetermined number of sets of the first and second loops corresponding to the predetermined number of first specific pitches and the one or more first loops corresponding to the one or more second specific pitches, and the outputter may add the predetermined number of first resonance signals generated in the first loops of the predetermined number of sets corresponding to the predetermined number of first specific pitches and the one or more first resonance signals generated in the one or more first loops corresponding to the one or more second specific pitches to one another, and outputs the first resonance signal acquired by addition.

In the embodiment, the excitation signal may be a sound signal indicating musical performance of a piano, or a sound signal that is acquired by extraction of an attack from a sound signal indicating a musical performance sound of a piano.

In the embodiment, the resonance signal generating device may further include a sound signal generator that generates a sound signal indicating a musical performance sound of a predetermined tone color in response to a detected musical performance operation, wherein the first resonance signal generator may supply the generated sound signal to the first loop as the excitation signal, and the outputter may add the generated sound signal and the first resonance signal to each other and output the added signal.

An electronic musical apparatus according to yet another aspect of the present invention includes the above-mentioned resonance signal generating device, a sound signal generator that generates a sound signal indicating a musical performance sound of a predetermined tone color in response to a detected musical performance operation, a supplier that supplies the sound signal generated by the sound signal generator to the first loop of the resonance signal generating device as the excitation signal, and a sound signal outputter that adds the sound signal generated by the sound signal generator and a sound signal output from an outputter of the resonance signal generating device to each other and outputs a sound signal acquired by addition.

According to yet another aspect of the present invention, a non-transitory computer readable medium stores a program that allows a computer to generate a first resonance signal of a specific pitch circulating through first loop processing by inputting an excitation signal to the first loop processing including first delay that delays the signal by a time corresponding to the specific pitch and first attenuation that attenuates the signal, generate a second resonance signal of the specific pitch circulating through second loop processing by the second loop processing including second delay that delays the signal by a time corresponding to the specific pitch and second attenuation that attenuates the signal, generate an attenuation change signal by adding the first and second resonance signals to each other, attenuating and inverting the added first and second resonance signals, and inputting the generated attenuation change signal to the first loop processing and the second loop processing respectively.

Further, a resonance signal generating device according to yet another aspect of the present invention includes a first resonance signal generating circuit that includes a first loop circuit including a first delay circuit that delays a signal by a time corresponding to a specific pitch and a first attenuation circuit that attenuates the signal, and an excitation input circuit that inputs an excitation signal to the first loop circuit, a second resonance signal generating circuit that includes a second loop circuit including a second delay circuit that delays the signal by a time corresponding to the specific pitch and a second attenuation circuit that attenuates the signal, an inversion input circuit that generates an attenuation change signal by adding a first resonance signal circulating through the first loop circuit and a second resonance signal circulating through the second loop circuit to each other, attenuating and inverting the added first and second resonance signals, and inputs the generated attenuation change signal to the first loop circuit and the second loop circuit respectively, and an output circuit that outputs the first resonance signal circulating through the first loop circuit.

The present invention can be applied in any embodiment such as a device, a method, a system, a program and a medium storing the program in addition to the above-mentioned embodiments.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a block diagram showing the hardware configuration of an electronic musical instrument according to one embodiment of an electronic musical apparatus including a resonance signal generating device according to one embodiment of the present embodiment;

FIG. 2 is a diagram showing the schematic functional configuration of the resonance signal generating device shown in FIG. 1;

FIG. 3 is a diagram showing the functional configurations of resonance signal generators and a propagator shown in FIG. 2 in further detail;

FIG. 4 is a flow chart of initial setting processing performed by a resonance setter shown in FIG. 2 at the time of start-up;

FIG. 5 is a flow chart of processing that is performed when the resonance setter detects a musical performance operation;

FIG. 6 is a diagram that shows the resonance signal generator and the propagator, corresponding to one pitch, extracted from the configuration of FIG. 3;

FIG. 7 is a diagram showing an example of a temporal change of the level of a first resonance signal (a resonance sound that is output by the resonance sound generating device) that is formed in response to an input of an excitation signal in the resonance signal generator of FIG. 6;

FIG. 8, corresponding to FIG. 7, is a diagram showing the example of a temporal change of the level of a first resonance signal in a comparative example;

FIG. 9, corresponding to FIG. 2, is a diagram showing the configuration of a modified example;

FIG. 10, corresponding to FIG. 6, is a diagram showing the configuration of another modified example; and

FIG. 11 is a diagram showing an example of the configuration of a circuit for simulating a resonance sound of a string.

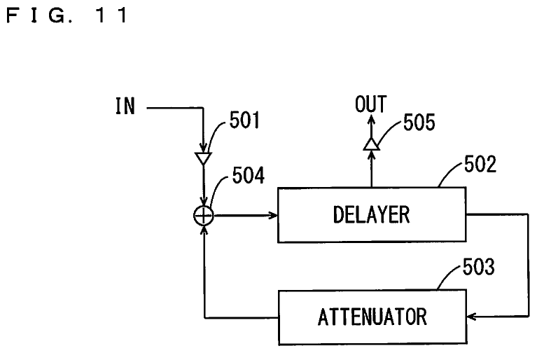

### DESCRIPTION OF THE PREFERRED EMBODIMENTS

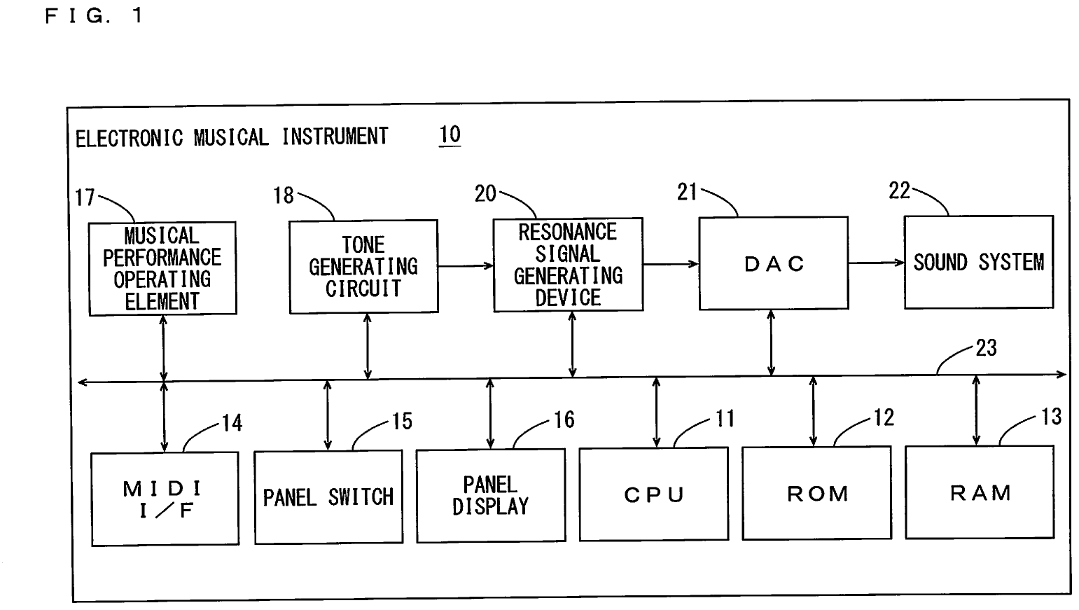

Embodiments of the present invention will be specifically described below based on the drawings. First, an electronic musical instrument according to one embodiment of an electronic musical apparatus including a resonance signal generating device according to the one embodiment of the present invention will be described. FIG. 1 is a diagram showing the hardware configuration of the electronic musical instrument.

As shown in this diagram, the electronic musical instrument 10 is provided with a CPU (Central Processing Unit) 11, a ROM (Read Only Memory) 12, a RAM (Random Access Memory) 13, a MIDI (Musical Instrument Digital Interface: registered trademark) _I/F (interface) 14, a panel switch 15, a panel display 16, a musical performance operating element 17, a tone generating circuit 18, a resonance signal generating device 20, a DAC (Digital-to-Analog Converter) 21 which are connected with a system bus 23, and is provided with a sound system 22.

The CPU 11 among these components is a controller that controls the electronic musical instrument 10 as a whole. The CPU 11 performs control operations of detecting an operation of the panel switch 15 or the musical performance operating element 17, controlling the display in the panel display 16, controlling the communication through the MIDI_I/F 14, controlling generation of a sound signal by the tone generating circuit 18 and the resonance signal generating device 20, controlling the DA conversion by the DAC 21, etc. by executing a control program stored in the ROM 12.

The ROM 12 is a rewritable non-volatile storage, such as a flash memory, which stores data that is not required to be changed too frequently such as a control program to be executed by the CPU 11, screen data representing the contents of the screen to be displayed in the panel display 16 and data of various parameters to be set in the tone generating circuit 18 and the resonance signal generating device 20.

The RAM 13 is a storage that is used as a working memory for the CPU 11.

The MIDI_I/F 14 is an interface for inputting and outputting MIDI data from or to an external device such as a MIDI sequencer that provides musical performance data representing a musical performance operation and the contents of musical performance such as designation of a tone color.

The panel switch 15 is an operating element such as a button, a knob, a slider or a touch panel that is provided on the operation panel of the electronic musical instrument 10, and is an operating element for receiving various instructions from a user such as settings of parameters and switching of screens or operation modes.

The panel display 16 is constituted by a liquid crystal display (LCD), a light emitting diode (LED) lamp and the like, and is a display unit for displaying an operational state and contents of settings of the electronic musical instrument 10, a message to the user, a graphical user interface (GUI) for receiving instructions from the user and so on.

The musical performance operating element 17 is an operating element for receiving a musical performance operation from the user, and includes a keyboard and a pedal such as the ones provided in an acoustic piano (hereinafter simply referred to as a “piano.”)

The tone generating circuit 18 is a sound signal generator that generates a sound signal (digital waveform data) indicating a musical performance sound of a predetermined tone color (a tone color of a piano, for example) according to a MIDI event that is generated by the CPU 11 in response to a detected operation of the musical performance operating element 17 or received from the MIDI_I/F 14.

For example, in response to detection of a note-on event, the tone generating circuit 18 can generate digital waveform data of the sound generated by the depression of the key corresponding to the pitch designated by the note-on event. As for the tone color of the piano, the tone generating circuit 18 can use the digital waveform data that is stored in a predetermined waveform memory in advance. In this case, keys of the actual piano are depressed one by one, and the sound generated by key depressions is stored in the waveform memory in advance in the form of the digital waveform data by the PCM (Pulse Code Modulation) method.

Such digital waveform data is stored in the waveform memory to correspond to the pitch corresponding to each key (and the velocity of a key depression). When the note-on event is detected, the tone generating circuit 18 can generate the waveform data corresponding to the key depression by reading the waveform data corresponding to the pitch (and the velocity) included in the event from the waveform memory and performing envelope processing or the like corresponding to the velocity and outputting the processed data. The tone color to be used can be selected from a plurality of candidates. The candidates may include the tone colors of a plurality of types of musical instruments or may include the tone colors of a plurality of different models of the same type of a musical instrument (a piano, for example).

Further, the tone generating circuit 18 outputs the generated sound signal to the sound system 22 through the resonance signal generating device 20 and the DAC 21. The CPU 11 may set the resonance signal generating device 20 such that all or part of the sound signal generated by the tone generating circuit 18 can be output without going through the resonance signal generating device 20.

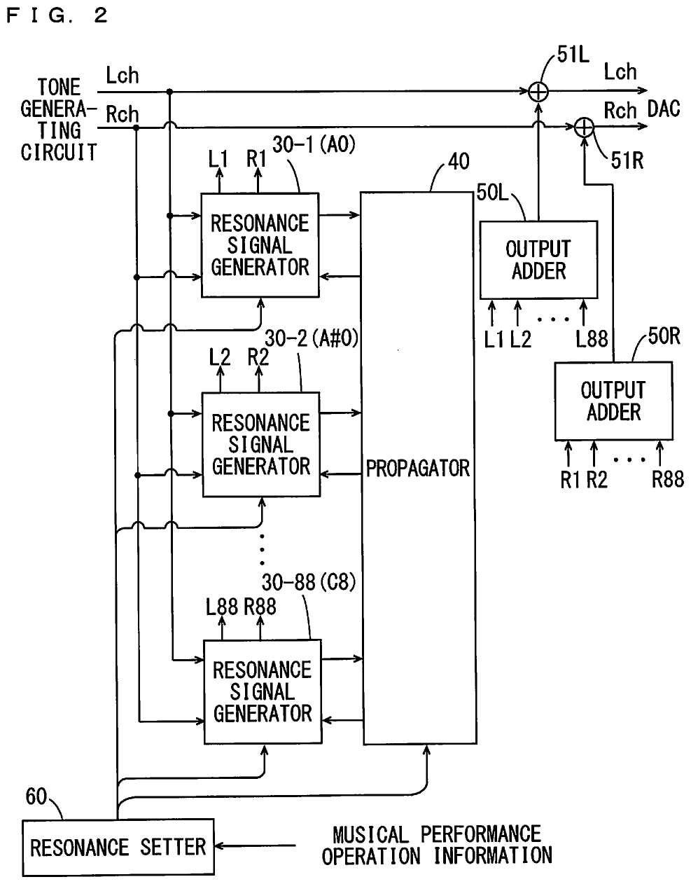

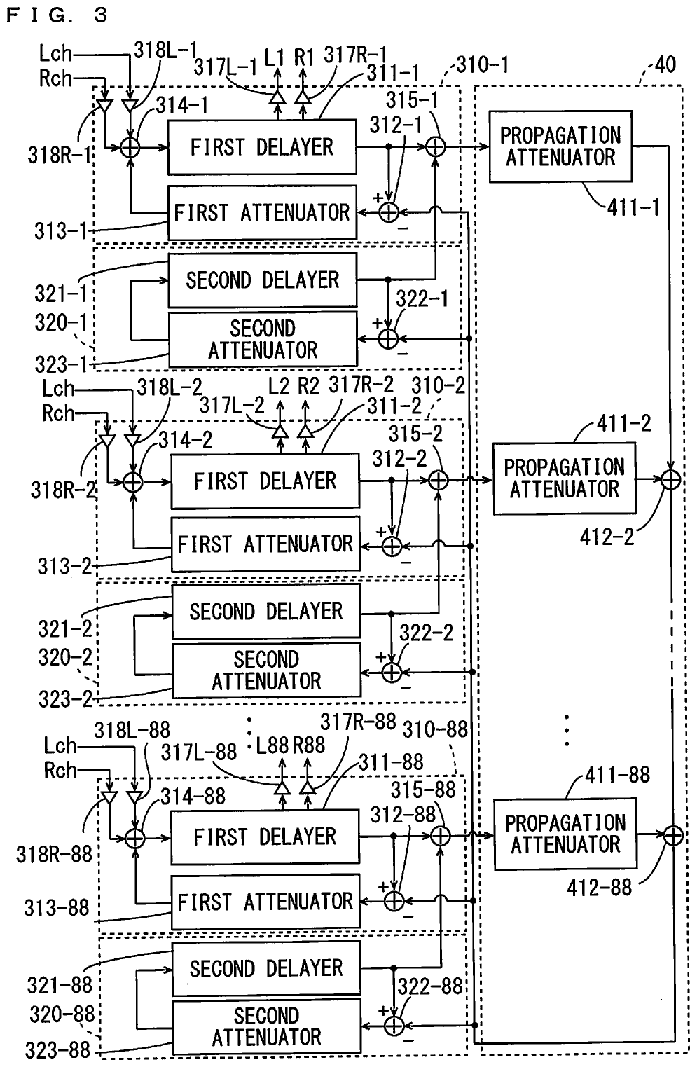

The resonance signal generating device 20 is one embodiment of the resonance signal generating device of the present invention, and generates a resonance signal simulating the resonance of a string excited by an input sound signal by performing the processing described in FIGS. 2, 3 and the like based on the sound signal that is input from the tone generating circuit 18. Further, the resonance signal generating device 20 adds this resonance signal to the sound signal that is input from the tone generating circuit 18 and outputs the added sound signal to the DAC 21.

The DAC 21 converts the digital sound signal that is output by the resonance signal generating device 20 into an analogue signal, and drives a speaker that constitutes the sound system 22. The sound system 22 is not required when the electronic musical instrument 10 is configured to output not sound but a sound signal. The DAC 21 is not required either when the electronic musical instrument 10 is configured to output not analogue but digital waveform data.

The above-mentioned electronic musical instrument 10 can generate a sound signal based on the musical performance with a resonance sound simulating the resonance of strings added, and output sound produced by the generated sound signal based on a user's musical performance operation detected by the musical performance operating element 17 or musical performance data received by the MIDI_I/F 14 from external equipment.

One of the features of this electronic musical instrument 10 is the configuration and operation of the resonance signal generating device 20 and will be described next.

First, FIG. 2 shows the schematic functional configuration of the resonance signal generating device 20. The function of each component shown in FIG. 2 may be realized by a dedicated circuit, execution of software by a processor or a combination of these. The same applies to the function of each component shown in FIG. 3 and the subsequent corresponding diagrams.

The resonance signal generating device 20 shown in FIG. 2 is configured to simulate the resonance of strings in the piano having 88 keys, by way of example, and includes resonance signal generators 30 that correspond to the pitches from the lowest pitch A0 (1st) to the highest pitch (C8) (88th). In the reference numeral “30-1,” the number following the hyphen indicates which pitch the constituent element corresponds to. However, when it is not necessary to distinguish the plurality of constituent elements from one another, the number following the hyphen is omitted, and a numeral reference such as “30” is used. This applies to other numeral references that include numbers following the hyphens.

Further, the resonance signal generating device 20 includes a propagator 40, output adders 50L, 50R, adders 51L, 51R, a resonance setter 60 in addition to the resonance signal generators 30.

Each resonance signal generator 30 among these components includes the function of receiving a sound signal supplied from the tone generating circuit 18 as an excitation signal and generating a resonance signal that simulates the resonance excited by the excitation signal for a string of the corresponding pitch, based on the sound signal. Here, each resonance signal generator 30 receives the sound signals of two channels of L and R, and outputs the resonance signals Ln, Rn (n is the number that represents the pitch) of two channels accordingly.

The propagator 40 includes the function of carrying out the calculation to simulate the structure such as a soundboard and a bridge of a piano for propagating vibration energy between strings. Each resonance signal generator 30 generates resonance signals while receiving a signal from this propagator 40. The functions of each resonance signal generator 30 and the propagator 40 will be described below with reference to FIG. 3.

The output adder 50L includes the function of adding resonance signals L1 to L88 of the L channel that are output respectively by the resonance signal generators 30 to one another and generating a resonance signal of the L channel as the output of the resonance signal generating device 20. The output adder 50R includes the function of similarly adding resonance signals R1 to R88 to one another and generating a resonance signal of the R channel.

The adders 51L, 51R are sound signal outputters and include the function of respectively adding the resonance signals generated by the output adders 50L, 50R to the sound signals supplied from the tone generating circuit 18 and outputting the added sound signals to the DAC 21. The adder 51L handles the sound signal of the L channel, and the adder 51R handles the sound signal of the R channel.

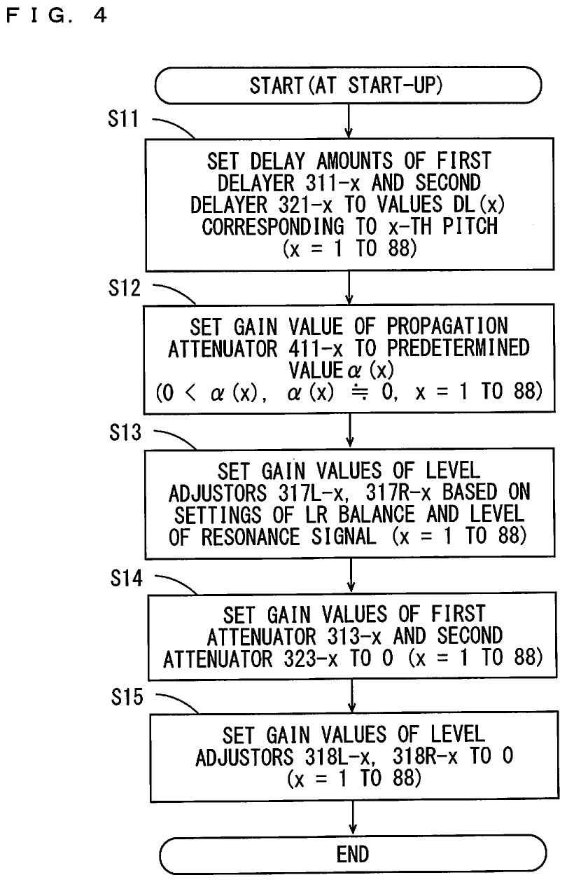

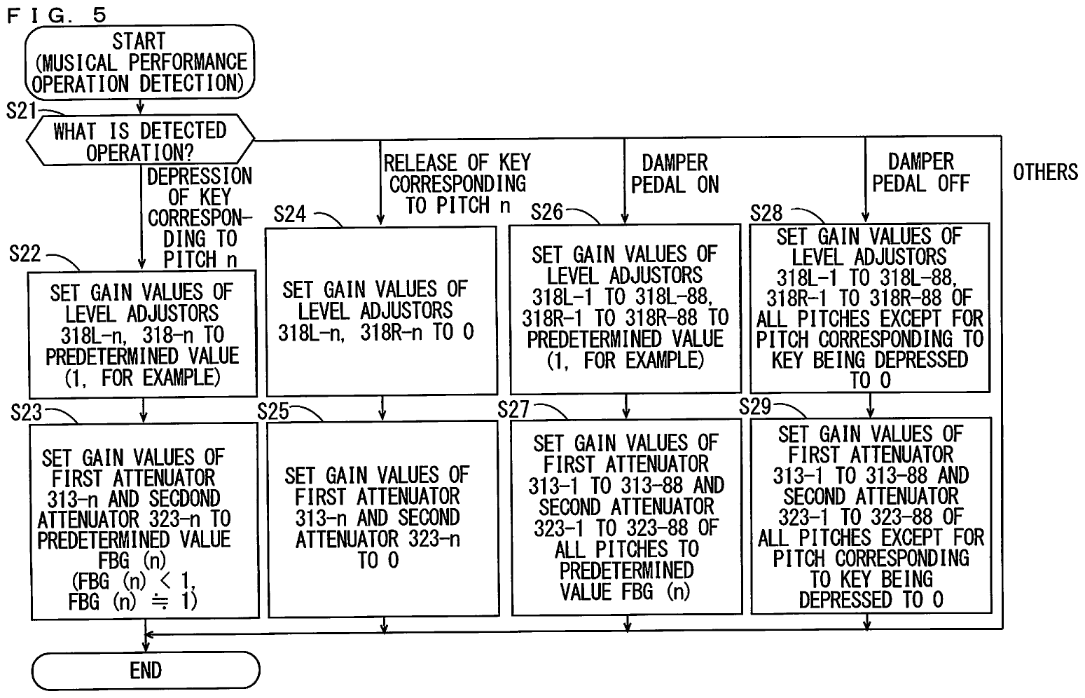

The resonance setter 60 includes the function of setting necessary parameters for each component of the resonance signal generating device 20 according to the musical performance data supplied from the CPU 11 at the time of start-up of the resonance signal generating device 20 or after the start-up. The parameters that are set by the resonance setter 60 will be described below in detail with reference to FIGS. 4 and 5.

Next, FIG. 3 shows the functional configurations of the resonance signal generators 30 and the propagator 40 shown in FIG. 2 in further detail.

FIG. 3 representatively shows only the resonance signal generators 30 corresponding to the first, second and 88th pitches. Each resonance signal generator 30 includes a first resonance signal generator 310 and a second resonance signal generator 320 as one resonance signal generator set.

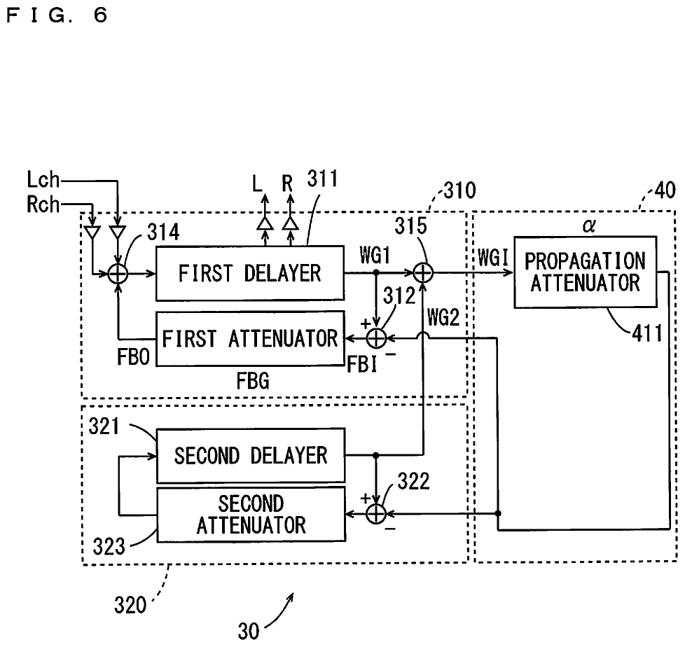

While one of the features of the present embodiment is that these second resonance signal generators 320 and the propagator 40 are provided in addition to the first resonance signal generators 310, the effects will be described below with reference to FIGS. 6 to 8. First, the functions of each component in FIG. 3 will be described.

Each first resonance signal generator 310 includes a first loop including a first delayer 311, an adder 312, a first attenuator 313 and an adder 314. Each first resonance signal generator 310 further includes an adder 315 and level adjustors 317L, 317R, 318L, 318R.

The first delayer 311 among these components includes the function of delaying a sound signal by holding each sample of an input sound signal for the time indicated by a delay amount DL set by the resonance setter 60 and then outputting the held sample. This first delayer 311 can be constituted by a buffer memory in which an output time point is settable on a sampling period basis of the sound signal. Further, the first delayer 311 can be constituted by a plurality of delay elements sequentially connected to one another. In such a first delayer 311, a position from which the sound signal is to be output is selectable from among the plurality of connection positions of the plurality of delay elements. Further, when the delay amount is to be set more finely than on a sampling period basis, a delay circuit using a primary all-pass filter as described in the JP 2015-143763 A may be provided in addition to the circuit that delays the sound signal on a sampling period basis.

Further, the first delayer 311 includes the function of outputting the input and held sound signal. The levels of these outputs are adjusted by the level adjustors 317L, 317R respectively, and these outputs are input to the output adders 50L, 50R of FIG. 2 as resonance signals of the L and R channels that are output by the resonance signal generator 30.

The adder 312 includes the function of adding a sound signal that is output by the first delayer 311 and a sound signal (attenuation change signal described below) that is acquired by inversion of the sound signal supplied from the propagator 40 to each other for every sample. Similar inversion input can be substantially carried out also by the circuit that calculates the difference between the sound signal that is output by the first delayer 311 and the sound signal that is supplied from the propagator 40.

The first attenuator 313 includes the function of attenuating the sound signal supplied from the adder 312 in accordance with the gain value set by the resonance setter 60. As described below, the resonance setter 60 sets the gain value simulating the state of the damper corresponding to the string for the first attenuator 313. As for the string against which the damper is abutting, the first attenuator 313 sets the gain value to 0 and simulates the sudden stop of string vibration. As for the string from which the damper is released, the first attenuator 313 sets the gain value to a value close to and smaller than 1, gradually attenuates the level of the signal to simulate the attenuation of the string vibration.

The adder 314 includes the function of an excitation inputter that inputs an excitation signal to the first loop by adding the excitation signals supplied from the tone generating circuit 18 and a sound signal that is output by the first attenuator 313 to each other.

In the present embodiment, the tone generating circuit 18 supplies the generated sound signals of the L and R channels to the resonance signal generating device 20. Therefore, when a plurality of keys are simultaneously depressed, and sound signals of a plurality of pitches are simultaneously generated in the tone generating circuit 18, the generated sound signals are supplied to the resonance signal generating device 20. Then, each first resonance signal generator 310 adjusts the respective levels of the sound signals of L and R channels by the respective level adjustors 318L, 318R and inputs the adjusted sound signals to the first loop through the adder 314 as excitation signals. These level adjustors 318L, 318R and the adder 314 are equivalent to a signal supplier.

For example, when the gain values set in the level adjustors 318L, 318R are both 1, the excitation signal that is input to the first resonance signal generator 310 is a sound signal that is acquired by simple addition of the sound signals of the L and R channels supplied from the tone generating circuit 18 to each other. However, the levels of the L and R channels may be individually adjustable.

In the above-mentioned first resonance signal generators 310, the constituent elements and the operations corresponding to the x-th pitch are described, by way of example. The value of a delay amount DL (x) is set in the first delayer 311-x such that the time required for one processing cycle by the first loop equals to one period of the sound of the x-th pitch (a reciprocal of the resonance frequency of the string of the x-th pitch). Thus, the component of the resonance frequency in the excitation signal (and components of its harmonics) is enhanced by addition of the signal that has been delayed by the first delayer 311 and the excitation signal of the next cycle to each other, and a first resonance signal having the resonance frequency of the string of the x-th pitch circulates through the first loop (the sound signal is subjected to the loop processing in the first loop.) Thus, the first resonance signal generator 310 can simulate the resonance of the string of the x-th pitch.

That is, the first resonance signal generator 310 can perform first resonance signal generation procedure that inputs the excitation signal to first loop processing including the first delay of the time corresponding to the x-th pitch and the first attenuation, and generates the first resonance signal of the x-th pitch circulating through the above-mentioned first loop processing.

The sound signal (attenuation change signal described below) that is input from the propagator 40 through the adder 312 has an effect on a resonance signal formed in the first loop similarly to an excitation signal that is input from the adder 314. However, because not having a sudden effect on the resonance signal as described below (the gain value of a propagation attenuator 411 is set not to cause the sudden effect,) the sound signal is not included in the excitation signal.

The first resonance signal generator 310 includes the function of supplying the output (a first resonance signal) of the first delayer 311 to the propagator 40 through the adder 315 in addition to the above-mentioned function.

On the other hand, each second resonance signal generator 320 includes a second loop including a second delayer 321, an adder 322 and a second attenuator 323. The functions of respective components forming this second loop are basically the same as those of the first delayer 311, the adder 312 and the first attenuator 313 that form the first loop. Further, the second delayer 321 does not output a resonance signal. Further, the second loop does not include the configuration equivalent to that of the adder 314, and an excitation signal is not input to the second loop.

The resonance setter 60 sets the same delay amount in the second delayer 321 as the delay amount that is set in the first delayer 311, and sets the same gain value in the second attenuator 323 as the gain value that is set in the first attenuator 313. However, when a piano is provided with a plurality of strings having slightly different resonance frequencies for one pitch, the delay amounts of the second delayer 321 and the first delayer 311 may be different from each other by a similar difference. The gain values of the second delayer 321 and the first delayer 311 may also be slightly different from each other.

The above-mentioned second resonance signal generator 320 corresponding to the x-th pitch, by way of example, includes the function of simulating the resonance caused by the string of the x-th pitch using the second loop. In response to some sort of an input signal, a second resonance signal having the resonance frequency of the string of the x-th pitch circulates through the second loop.

That is, the second resonance signal generator 320 can perform second resonance signal generating procedure that inputs not the excitation signal but the signal supplied from the propagator 40 to second loop processing including second delay of the time corresponding to the x-th pitch and second attenuation and generates the second resonance signal of the x-th pitch circulating through the above-mentioned second loop processing.

This simulating function itself is the same as the function of the corresponding first resonance signal generator 310. However, the input to the second resonance signal generator 320 is mainly from the propagator 40 through the adder 322. Therefore, the second resonance signal is formed in accordance with the sound signal that is input from the propagator 40. The second resonance signal generator 320 is provided to adjust the attenuation rate of the first resonance signal in the first resonance signal generator 310 by this second resonance signal.

Further, the second resonance signal generator 320 also includes the function of supplying the output (the second resonance signal) of the second delayer 321 to the propagator 40 through the adder 315 in addition to the above-mentioned function. The adder 315 adds the first resonance signal and the second resonance signal to each other, and supplies the sound signal acquired by addition (sound signal of sum) to the propagator 40.

Next, the propagator 40 includes propagation attenuators 411 respectively corresponding to the resonance signal generators 30 and adders 412 respectively corresponding to the second and subsequent resonance signal generators 30. The propagator 40 includes the function of receiving the sound signal of sum supplied from the adder 315 of each resonance signal generator 30, attenuating the sound signal by the corresponding propagation attenuator 411 and then adding the attenuated sound signal and the sound signal attenuated by another propagation attenuator 411 to each other by each adder 412.

Further, the propagator 40 includes the function of inputting an inversion signal that is acquired by inversion of the positive and negative of the sound signal added by the adder 412-88 corresponding to all of the strings to the first resonance signal generator 310 and the second resonance signal generator 320 of each resonance signal generator 30 as the attenuation change signal. More specifically, the propagator 40 inputs the added sound signal to the first loops through the adders 312, and inputs the added sound signal to the second loops through the adders 322. That is, the propagator 40 functions as an inversion inputter along with the adders 312 and the adders 322. Further, the propagator 40 can perform the procedure of inputting the inversion signal to the first loop processing and the second loop processing.

The attenuation processing in each propagation attenuator 411 is performed based on a gain value α that is set by the resonance setter 60. The propagation of vibration energy to be simulated by this propagator 40 is slow, so that the value of α is a positive value close to 0 in reflection to this. A common value or different values may be set for the propagation attenuators 411 of respective pitches.

The above-mentioned propagator 40 adds the sound signals that are input from respective resonance signal generators 30 to one another and returns the results of addition to all of the resonance signal generators 30, thereby being able to simulate how the vibration of one string is propagated to another string through a soundboard or a bridge, for example. While the propagator 40 inputs the result of addition to each resonance signal generator after inverting the signal so as to simulate the reflection of vibration of a string by a bridge, this inversion allows the second resonance signal generators 320 to be effective. The effects will be described below with reference to FIGS. 6 to 8.

Processing of setting a value of a parameter in each component of the resonance signal generating device 20, which is performed by the resonance setter 60 shown in FIG. 2, will be described next.

First, FIG. 4 shows a flow chart of initial setting processing that is performed by the resonance setter 60 at the time of start-up.

When the resonance signal generating device 20 is started up, the resonance setter 60 performs the processing of FIG. 4 and the initial setting of a value of a parameter in each component. Since being performed for the respective first to 88th pitches, the processing of each step in FIG. 4 is generalized as the processing relating to the x-th pitch for description.

In the processing of FIG. 4, the resonance setter 60 first sets the delay amounts of each first delayer 311-x and each second delayer 321-x to the values DL (x) respectively corresponding to the x-th pitch (S11). The value of DL(x) corresponding to each value of x may be prepared in advance, or obtained by calculation from the frequency of each pitch. As described above, (substantially) the same value is set for the first delayer 311-x and the second delayer 321-x.

Next, the resonance setter 60 sets the gain value of the propagation attenuator 411-x to a pre-saved predetermined value α (x) (S12). Each α (x) is a positive value close to 0 as described above.

Further, the resonance setter 60 sets the gain values of the level adjustors 317L-x, 317R-x based on the settings of the LR balance and the level of a resonance signal that are supplied from the CPU 11 (S13). The CPU 11 also supplies the setting of the LR balance (sound image localization position) that is the same as the LR balance supplied to the tone generating circuit 18 to the resonance setter 60. Further, the CPU 11 also supplies the setting of the level of the resonance signal to the resonance setter 60. The level of the resonance signal is set according to a user's operation or set automatically, which indicates the level of the resonance signal to be applied to the sound signal generated by the tone generating circuit 18. The gain values of the level adjustors 317L-x, 317R-x can be obtained in advance by multiplication of the gain value corresponding to the LR balance by the gain value indicated by the level of the resonance signal (addition if the gain value is an index value).

The resonance setter 60 further sets the gain values of the first attenuator 313-x and the second attenuator 323-x to 0 (S14), also sets the gain values of the level adjustors 318L-x, 318R-x to 0 (S15) and ends the processing of FIG. 4. The settings of the step S14 and S15 are made to simulate the dampers abutting against all of the strings in an initial state.

Next, FIG. 5 shows a flow chart of the processing performed when the resonance setter 60 detects a musical performance operation.

The CPU 11 also supplies the data pieces relating to a key depression, a key release and a damper pedal operation among the musical performance data supplied to the tone generating circuit 18 to the resonance signal generating device 20 at the same time. When this musical performance data is supplied after the initial setting is completed, the resonance setter 60 starts the processing shown in the flow chart of FIG. 5, assuming that a musical performance operation has been detected.

In the processing of FIG. 5, the resonance setter 60 determines the type of the detected operation (S21) and performs the processing according to the determined type.

First, when detecting an operation of depressing the key of the n-th pitch (note), the resonance setter 60 sets both of the gain values of the level adjusters 318L-n, 318R-n of the n-th pitch to predetermined values (S22), and sets both of the gain values of the first attenuator 313-n and the second attenuator 323-n of the n-th pitch to a predetermined value FBG (n) that is pre-saved (S23).

In accordance with the settings made in the step S22, the sound signals supplied from the tone generating circuit 18 are input to the first resonance signal generator 310-n of the n-th pitch as an excitation signal. Further, the FBG (n) is the value, which is mentioned in the description of the first attenuator 313, is prepared in correspondence with the n-th pitch as the value simulating the attenuation of string vibration. These settings are made to simulate the damper being released from the string in response to a key depression, and the resonance signals can be respectively generated in the first loop and the second loop of the n-th pitch according to these settings.

While the gain values that are set in the step S22 may be 1, for example, the gain values may be calculated in advance based on the settings of the LR balance and the level of the resonance signal that are supplied from the CPU 11. Further, the LR balance to be used for the settings of the gain values of the level adjustors 318-Lx, 318-Rx does not necessarily be the same as the LR balance to be supplied to the tone generating circuit 18 (the LR balance to be used for the settings of the gain values of the level adjustors 317L-x, 317R-x), and may be set separately for adjusting the input to the resonance sound generating circuit 30. The LR balance may be set for every pitch or every predetermined number of pitches.

Next, when an operation of releasing the key of the n-th pitch is detected, the resonance setter 60 sets both of the gain values of the level adjustors 318L-n, 318R-n of the n-th pitch to 0 (S24), and sets both of the gain values of the first attenuator 313-n and the second attenuator 323-n of the n-th pitch to 0 (S25).

In accordance with the settings made in the step S24, an excitation signal is not input to the first resonance signal generator 310-n of the n-th pitch. In accordance with the settings made in the step S25, the resonance signals that have been circulating through the first loop and the second loop are also quickly attenuated and substantively not output from the first resonance signal generator 310-n. These settings are made to simulate the damper abutting against the string in response to a key release.

Next, when an ON operation of a damper pedal is detected, the resonance setter 60 sets the gain values of the level adjustors 318L-1 to 318L-88, 318R-1 to 318R-88 of all of the pitches to predetermined values (S26), and sets the gain values of the first attenuators 313-1 to 313-88 and the second attenuators 323-1 to 323-88 of all of the pitches to predetermined values FBG (x) that is pre-saved respectively corresponding to respective pitches (S27). These settings are made to simulate the dampers of all of the pitches being released from the strings due to the depression of the damper pedal.

The gain values that are set in the step S26 may also be 1 similarly to the settings made in the step S22, or may be calculated in advance based on the settings of the LR balance and the level of the resonance signal.

Next, when an OFF operation of the damper pedal is detected, the resonance setter 60 sets the gain values of the level adjusters 318L-1 to 318L-88 and 318R-1 to 318R-88 of all of the pitches except for the pitch corresponding to the key being depressed to 0 (S28), and sets the gain values of the first attenuators 313-1 to 313-88 and the second attenuators 323-1 to 323-88 of all of the pitches except for the pitch corresponding to the key being depressed to 0 (S29). These settings are made to simulate the dampers, of all of the pitches except for the pitch corresponding to the key being depressed, abutting against the strings due to the release of the damper pedal. As for the pitch corresponding to the key being depressed, the damper is released from the string regardless of the state of the damper pedal.

The resonance setter 60 performs the above-mentioned processing of FIGS. 4 and 5, so that the resonance signal generating device 20 can generate the resonance signal that simulates the resonance caused by vibration of each string by simulating the operation of an actual piano in response to an operation of the keyboard and the damper pedal of the piano.

In addition to the above-mentioned processing, it is conceivable that the gain values of the level adjustors 317L, 317R are changed depending on whether the damper pedal is in an ON state. For example, the gain values of the level adjustors 317L-1 to 317L-88, 317R-1 to 317R-88 of all of the pitches are set to first setting values in response to a trigger caused by a damper pedal ON state, or the gain values of the level adjustors 317L-1 to 317L-88, 317R-1 to 317R-88 of all of the pitches are set to second setting values in response to a trigger caused by a damper pedal OFF state.

Next, the effects of the above-mentioned embodiment will be described with reference to FIGS. 6 to 8.

FIG. 6 is a diagram showing a resonance signal generator 30 (a set of a first resonance signal generator 310 and a second resonance signal generator 320) and the propagator 40, corresponding to one pitch, extracted from the configuration of FIG. 3 in order to facilitate understanding of the description of the effects. However, as being apparent from the description of FIG. 4 or 5, with only one key being depressed in the musical performance operating element 17, only the resonance signal generator 30 of the pitch corresponding to the key being depressed is able to generate and output a resonance signal, and the functions of the other resonance signal generators 30 are stopped substantively. Therefore, with only one key being depressed, the functions of the resonance signal generators 30 and the propagator 40 shown in FIG. 3 are substantively equivalent to the functions shown in FIG. 6.

In the configuration of FIG. 6, the level of the signal (first resonance signal) that is output by the first delayer 311 is WG1, and the signal (second resonance signal) that is output by the second delayer 321 is WG2. Further, the level of the signal supplied to the propagator 40 through the adder 315 is WGI. Further, when letting the gain value of the propagation attenuator 411 be α(≈0), the level of the signal supplied from the propagator 40 to the adder 312 and the adder 322 is α×WGI.

Here, the state right after a key is depressed (a string is hit due to a key depression) when the string has been in a stationary state, that is, right after an excitation signal is input when the first and second resonance signals have been flat (WG1, WG2=0) is considered.

Because WG2≈0 at this time point, WGI≈WG1. Therefore, when letting the level of an input signal to the first attenuator 313 be FBI, the following formula holds.

FBI≈WG1−α×WG1=(1−α)WG1 (Formula 1)

It can be considered that there is substantially no delay in the signal supplied from the propagator 40 to the adder 312 as compared to the signal supplied from the adder 315 to the propagator 40. Even if there is some delay, the signal is delayed to an ignorable extent in the calculation of the level. Therefore, in the calculation carried out in the adder 312, part of the first resonance signal is canceled by the first resonance signal that is attenuated to a times and then inverted.

Next, when letting the gain of the first attenuator 313 be FBG, the level FBO of the signal that is output by the first attenuator 313 is expressed in the following formula.

FBO=FBG×FBI≈FBG×(1−α)WG1={FBG×(1−α)}WG1 (Formula 2)

Further, if the propagator 40 (an input of an inversion signal from the propagator 40) is not present, the following formula is to hold.

FBO=FBG×FBI=FBG×WG1 (Formula 3)

When the formula 2 and the formula 3 are compared to each other, it is found that the provision of the propagator 40 causes the gain of the first attenuator 313 to decrease to (1−α) times and causes the attenuation rate of the first resonance signal to increase.

In the meantime, the signal that is generated by attenuation of the first resonance signal and inversion of the positive and negative of the first resonance signal is input to the second loop from the adder 322. The second loop is configured such that the resonance signal having the same frequency as that of the first loop circulates through the second loop. Thus, although the input signal is attenuated by the second attenuator 323, another reason does not cause the signal to be attenuated too much. Therefore, the energy is accumulated, and the level of the second resonance signal formed in the second loop gradually increases as the input continues.

As being apparent from the original input, this second resonance signal is a signal obtained by inversion of the positive and negative of the first resonance signal (that is, the phase is shifted by half of a period.) Therefore, as the level of the second resonance signal increases, the first resonance signal and the second resonance signal cancel each other in the adder 315, so that the level of the input signal to the propagator 40 decreases.

That is, WGI=WG1−WG2 holds substantively. Therefore, the level of the signal that is supplied to the propagator 40 and returned to the adders 312, 313 gradually decreases, so that the rate at which the level of the second resonance signal increases gradually decreases. Further, when letting WGI at one time point be K (0≤K<1) times of WG1, FBO at that time point is expressed in the following formulas.

FBI≈WG1−α×K×WG1=(1−Kα)WG1 (Formula 4)

FBO=FBG×FBI≈FBG×(1−Kα)×WG1={FBG×(1−Kα)}WG1 (Formula 5).

That is, the gain of the first attenuator 313 caused by the provision of the propagator 40 is decreased to (1−kα) times, and the attenuation rate is slower than the attenuation rate in the beginning.

When a predetermined time elapses, WG1≈WG2. In this state, WGI≈0, and the level of the signal supplied to the propagator 40 is substantially zero. Therefore, the signal supplied from the propagator 40 to each loop does not have an effect on the first resonance signal and the second resonance signal.

In this state, the first resonance signal and the second resonance signal are attenuated at the same rate by the first attenuator 313 and the second attenuator 323 while respectively maintaining the same level, and this state continues until the level becomes substantively zero.

In this state, K≈0, FBO≈FBG×WG1, and the first resonance signal is attenuated exponentially at a predetermined rate that is slower than the rate right after a key depression.

In this manner, in the resonance signal generating device 20, the first resonance signal generator 310 for generating the output resonance signal (first resonance signal) and the second resonance signal generator 320 having the same resonance frequency and attenuation rate are provided, and the propagator 40 is further provided, in the resonance signal generator 30 of each pitch. Thus, with relatively simple processing, the resonance signals that are smoothly and continuously attenuated in two stages can be generated at any resonance frequency. The two stages includes the fast attenuation that is carried out right after a key depression and the slow attenuation that is carried out after the fast attenuation. The attenuation change signal is obtained by adding the first resonance signal circulating through the first loop and the second resonance signal circulating through the second loop, attenuating and inverting the added first and second resonance signals. The attenuation change signal has the function of changing the attenuation rate of the output first resonance signal in two stages.

That is, the configuration of the present embodiment enables generation of a signal of a resonance sound simulating the attenuation of the level in two stages as in a piano with a small processing load. The piano is taken as one example of a musical instrument, and the present invention is applicable to the generation of resonance sounds of string in another musical instrument having a plurality of arranged strung strings.

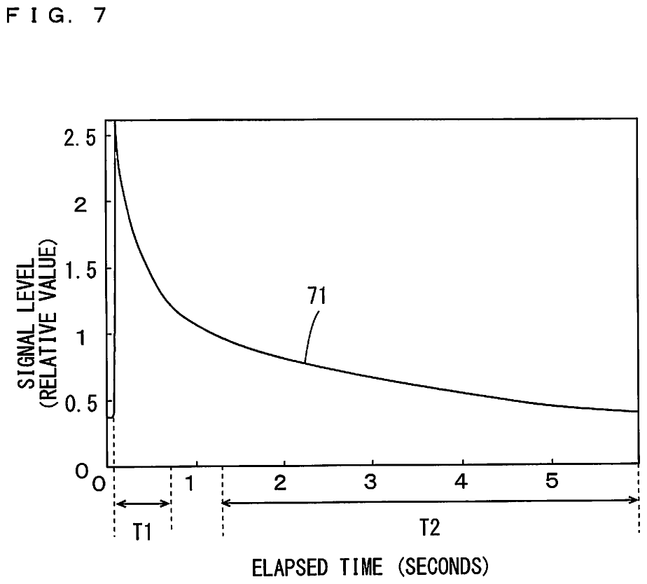

FIG. 7 shows an example of the result of simulation of the temporal change of the level of the first resonance signal that is formed in response to an input of an excitation signal in the resonance signal generator 30 of FIG. 6. The abscissa indicates the elapsed time, and the ordinate indicates a relative value of the level. Both are linear scales. The solid line 71 indicates the change of the signal level.

As can be taken from FIG. 7, the first resonance signal is attenuated rapidly in a period T1 right after the input of the excitation signal. Then, the attenuation rate slows down smoothly, and the first resonance signal is substantially exponentially attenuated in a period T2. The example of FIG. 7 shows the acquired data relating to the 39th pitch with FBG=0.9985, α=0.006.

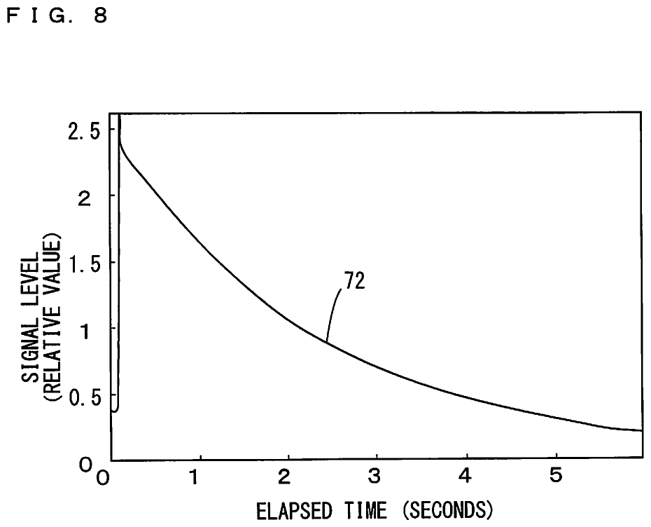

Further, as a comparative example, FIG. 8 shows the example of the simulation result of the temporal change of the level of the resonance signal that is formed in response to an input of an excitation signal in a resonance signal generator that is equivalent to the first resonance signal generator 310 in the case where the second resonance signal generator 320 and the propagator 40 are not present. In FIG. 8, the units of the ordinate and abscissa are common to those in FIG. 7, and the solid line 72 indicates the change of the signal level.

In the example of FIG. 8, except for the unstable period right after the input of the excitation signal, the level of the resonance signal is attenuated exponentially at a predetermined rate corresponding to the value of FBG and the period of the loop processing over the entire time, and is not attenuated in two stages.

While the foregoing description of the embodiment is completed, the configuration of the device, the specific contents and procedures of the processing and calculation, the number of the resonance signal generators and so on, as a matter of course, are not limited to the description made in the above-mentioned embodiment.

The 88 resonance signal generators 30 corresponding to the piano having 88 strings are provided in the above-mentioned embodiment, by way of example. However, the number of the resonance signal generators 30 can be any number. Even when the tone color of a piano is to be simulated, it is not essential to provide the resonance signal generators 30 corresponding to all strings. When a piano other than the piano having 88 keys is simulated, the number of resonance signal generators 30 to be provided corresponds to the number of keys included in the piano.

Further, in a musical instrument such as a piano, a plurality of strings having slightly different resonance frequencies may be provided for one pitch. Accordingly, it is conceivable that a plurality of resonance signal generators 30 that generate resonance signals of the resonance frequencies respectively corresponding to the strings are provided for one pitch.

Further, pitches to be used are not limited to be in accordance with equal temperament.

While the sets of the first resonance signal generator 310 and the second resonance signal generator 320 are provided in the resonance signal generators 30 corresponding to all of the pitches in the above-mentioned embodiment, it is not essential. Sets of the first resonance signal generator 310 and the second resonance signal generator 320 may be provided only for part of the pitches, and only first resonance signal generators 310 may be provided for the other pitches.

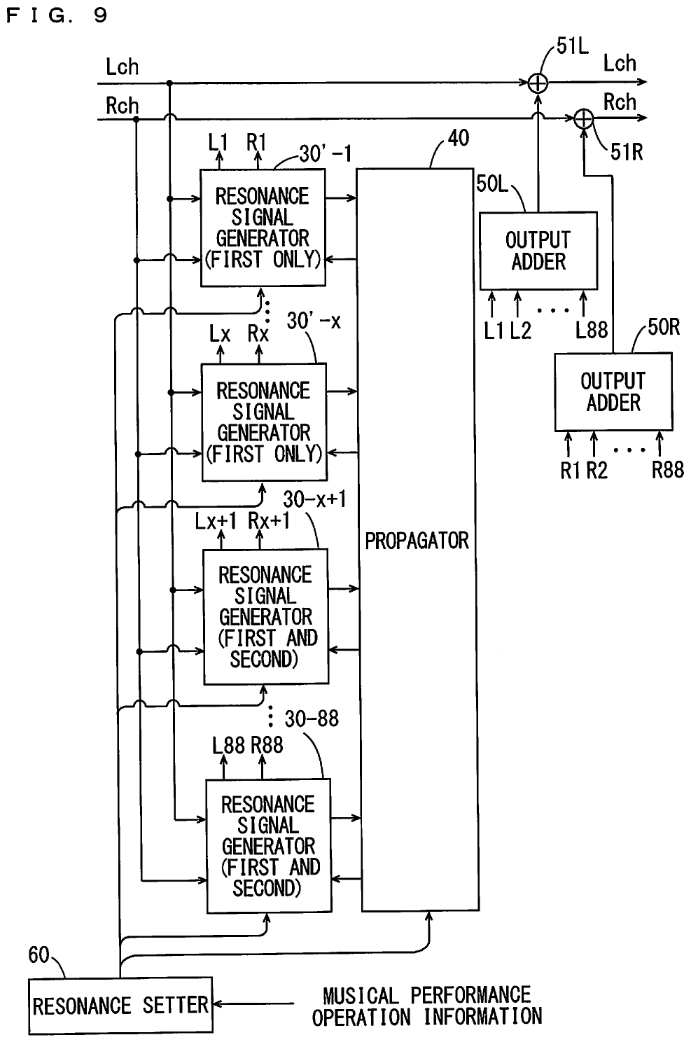

FIG. 9 shows the example of such a configuration. FIG. 9, corresponding to FIG. 2, shows the functional configuration of a resonance signal generating device 20 in which sets of a first resonance signal generator 310 and a second resonance signal generator 320 are provided in a resonance signal generator 30 for each of the pitches from the (x+1)th to 88th pitches from the highest sound, and a second resonance signal generator 320 is not provided and only a first resonance signal generator 310 is provided for each of the pitches from the 1st to x-th pitches from the lowest sound (x is equal to or higher than 1.) When a second resonance signal generator 320 is not provided, an adder 315 is not required.

Since certain resources are required for provision of the second resonance signal generators 320, the second resonance signal generators 320 may be provided limitedly for the range of the pitches corresponding to more important resonance signals. In this case, resources can be saved. Here, the resources include a mounting area, the number of components and the like for circuits, and include processing capability of a processor for software.

Since the delay time in each second delayer 321 for lower pitches is longer, the amount of resources required for the second resonance signal generators 320 is larger. Thus, if available resources are the same, it is desirable that the second resonance signal generators 320 are provided in a descending order from the highest pitch within the range allowed by the resources. This enables provision of the second resonance signal generators 320 corresponding to the wide range of pitches.

Further, in addition to the above-mentioned modification, a low-pass filter for simulating the change in vibration caused by characteristics of a soundboard and a bridge may be provided to follow the final adder 412-88 in the propagator 40.

While the first resonance signal generator 310 and the second resonance signal generator 320 are provided for each of a predetermined number of different pitches from the highest sound and only the first resonance signal generator 310 is provided for each of one or more pitches from the lowest sound in the example of FIG. 2, the first resonance signal generator 310 and the second resonance signal generator 320 may be provided for each of a predetermined number of pitches in any higher range and only the first resonance signal generator 310 may be provided for each of one or more pitches in any lower range.

Further, it is conceivable that a plurality of second resonance signal generators 320 (resonance signal generators that do not receive excitation signals or generate output resonance signals) are provided in parallel to one resonance signal generator 30.

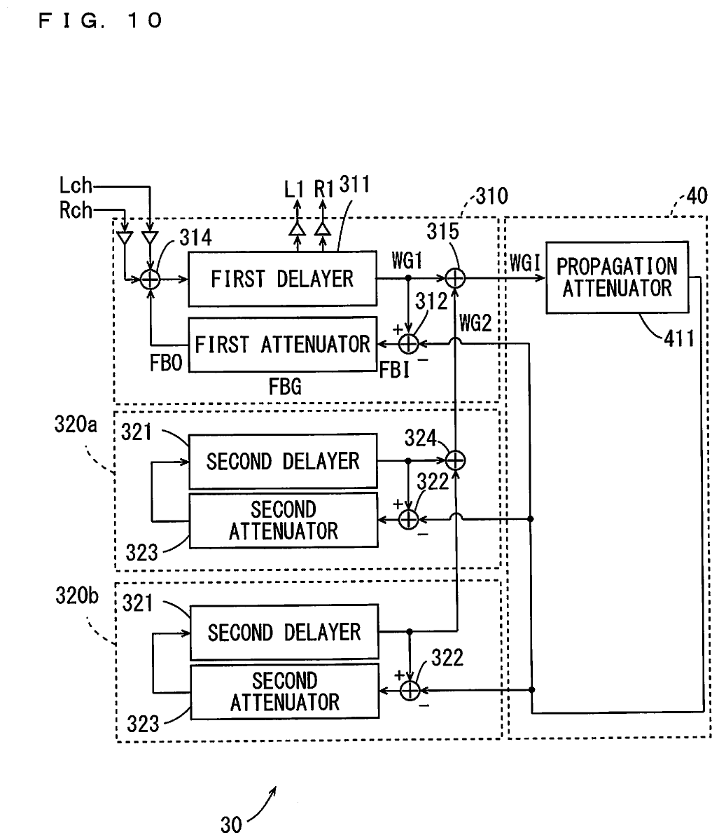

FIG. 10 shows the configurations of a resonance signal generator 30 and a propagator 40 in the case where two second resonance signal generators 320 are provided. Similarly to FIG. 6, FIG. 10 shows only a resonance signal generator 30 corresponding to one pitch.

In the configuration of FIG. 10, a second resonance signal generator 320a and a second resonance signal generator 320b are provided in the resonance signal generator 30. The second resonance signal generator 320a and the second resonance signal generator 320b basically have the same configuration. Substantially the same delay amount is set for each second delayer 321, and the same gain value is set for each second attenuator 323. However, the second resonance signal generator 320a includes an adder 324, adds a resonance signal formed in a loop of the second resonance signal generator 320b and a resonance signal formed in a loop of the second resonance signal generator 320a to each other, and outputs the added resonance signal to an adder 315. Therefore, the signal that is acquired by addition of the resonance signals formed in the three resonance signal generators is input to the propagator 40.

Such a configuration enables generation of a resonance signal, the level of which changes in a more complicated manner than the change caused by the configuration of FIG. 6.

Further, it is conceivable that the propagator 40 is provided to correspond to each pitch as yet another modification. When the propagation of vibration of strings ranging over pitches is not simulated, the propagator 40 may at least propagate the vibration from a first resonance signal generator 310 to a second resonance signal generator 320 in one resonance signal generator 30. In this case, the configuration in which the propagator 40 that propagates a signal relating to one resonance signal generator 30 is provided for every resonance signal generator 30 as shown in FIG. 6 is conceivable.

Further, in the above-mentioned embodiment, the resonance signal generating device 20 is configured as a unit incorporated in the electronic musical instrument 10, by way of example. However, the resonance signal generating device 20 can be configured as an independent device including the function of generating a resonance signal indicating a resonance sound of a string excited by an input sound signal based on the sound signal, for example. In this case, the resonance signal generating device 20 can be configured to control each component shown in FIG. 2 by a computer constituted by a CPU, a ROM, a RAM and so on. Alternatively, the resonance signal generating device 20 can be configured to realize the function of each component shown in FIG. 2 by allowing a computer to execute a necessary program. The program, in this case, is an embodiment of the present invention.

Such a program may be stored in a ROM or another non-volatile recording medium (a flash memory, an EEPROM or the like) originally included in the computer. However, the program can be recorded in any non-volatile recording medium such as a memory card, a CD, a DVD or a blue-ray disc to be provided. It is possible to realize each above-mentioned function by installing the program recorded in each of these recording media in the computer and executing the program.

Further, it is also possible to download the program from an external device that is connected to a network and includes a recording medium recording the program or an external device having a storage storing the program, install the program in the computer and execute the program.

Further, in addition to being configured as the electronic musical instrument 10, the electronic musical apparatus of the present invention can also be configured as a tone generation device that does not include a musical performance operating element 17 but generates sound data of a musical piece in accordance with musical performance data that is supplied externally. Further, the method of generating sound data is not limited to the PCM method, and any method such as an FM (Frequency Modulation Method) can be employed.

While the sound signal generated by the tone generating circuit 18 is used as an excitation signal without modification in the above-mentioned embodiment, by way of example, the signal that is acquired by a process such as extraction of an attack may be used as an excitation signal. Alternatively, if the resources allow, a sound signal of sound of a key depression and a sound signal for excitation may be generated separately as sound signals having different tone colors based on one musical performance operation, and the latter may be used as an excitation signal.

Further, the functions of each device described above can be distributively provided in a plurality of devices, and the functions similar to the functions of each above-mentioned device can be realized by cooperation of the plurality of devices.

Further, as a matter of course, the configurations of each embodiment and the modified example that have been described above can be implemented in combination with one another to the extent not inconsistent with one another.

As being apparent from the above-mentioned description, the above embodiments enables the generation of a signal of a resonance sound simulating the attenuation of the level in two stages as in a piano with a small processing load. Thus, the device that outputs sound or its sound signal similar to an actual musical instrument can be provided at low cost.

I/We claim:

1. A resonance signal generating method comprising:
generating a first resonance signal of a specific pitch circulating through first loop processing by inputting an excitation signal to the first loop processing including first delay that delays the signal by a time corresponding to the specific pitch and first attenuation that attenuates the signal;
generating a second resonance signal of the specific pitch circulating through second loop processing by the second loop processing including second delay that delays the signal by a time corresponding to the specific pitch and second attenuation that attenuates the signal;
generating an attenuation change signal by adding the first resonance signal and the second resonance signal to each other, attenuating and inverting the added first and second resonance signals, and inputting the generated attenuation change signal to the first loop processing and the second loop processing; and
outputting the first resonance signal.

2. The resonance signal generating method according to claim 1, wherein
the generating the first resonance signal includes generating the first resonance signal circulating through the first loop processing by adding the signal attenuated by the first attenuation and the input excitation signal to each other, delaying the added signal by the first delay, adding the signal delayed by the first delay and the input attenuation change signal to each other, and attenuating the added signal by the first attenuation, and
the generating the second resonance signal includes generating the second resonance signal circulating through the second loop processing by delaying the signal attenuated by the second attenuation by the second delay, adding the signal delayed by the second delay and the input attenuation change signal to each other, and attenuating the added signal by the second attenuation.

3. The resonance signal generating method according to claim 1, wherein
a delay amount of the first delay is set such that a time required for one circulation of the signal in the first loop processing is equal to one period of the specific pitch sound.

4. The resonance signal generating method according to claim 1, wherein
the generating the first and second resonance signals includes generating a plurality of sets of the first and second resonance signals respectively by a plurality of sets of the first and second loop processing, and the plurality of sets of the first and second loop processing correspond to a plurality of the different specific pitches,
the inputting the attenuation change signal includes generating attenuation change signals corresponding to specific pitches by adding to one another, attenuating and inverting the first and second resonance signals generated in each set of the first and second loop processing, and inputting a common attenuation change signal acquired by calculation of a plurality of the attenuation change signals corresponding to the plurality of specific pitches or a plurality of the attenuation change signals corresponding to the plurality of specific pitches, to the plurality of sets of the first and second loop processing respectively, and
the outputting the first resonance signal includes adding the plurality of first resonance signals generated in the first loop processing of the plurality of sets to one another and outputting the first resonance signal acquired by addition.

5. The resonance signal generating method according to claim 3, wherein
the specific pitch includes a predetermined number of different first specific pitches in a higher range and one or more second specific pitches in a lower range,
the first and second loop processing include the predetermined number of sets of the first and second loop processing corresponding to the predetermined number of first specific pitches and one or more first loop processing corresponding to the one or more second specific pitches,
the generating the first and second resonance signals includes generating the first and second resonance signals in the predetermined number of sets by the predetermined number of sets of the first and second loop processing corresponding to the predetermined number of first specific pitches, and generating one or more first resonance signals by the one or more first loop processing corresponding to the one or more second specific pitches,
the generating the attenuation change signal includes generating the predetermined number of attenuation change signals corresponding to the predetermined number of first specific pitches by adding the first and second resonance signals in each set corresponding to the predetermined number of first specific pitches to each other, attenuating and inverting the added first and second resonance signals, and generating one or more attenuation change signals corresponding to the one or more second specific pitches by attenuating and inverting the one or more first resonance signals corresponding to the one or more second specific pitches, and respectively inputting a common attenuation change signal acquired by calculation of the predetermined number of attenuation change signals corresponding to the predetermined number of first specific pitches and the one or more attenuation change signals corresponding to the one or more second specific pitches, or the predetermined number of attenuation change signals corresponding to the predetermined number of first specific pitches and the one or more attenuation change signals corresponding to the one or more second specific pitches, to the predetermined number of sets of the first and second loop processing corresponding to the predetermined number of first specific pitches and the one or more first loop processing corresponding to the one or more second specific pitches, and
the outputting the first resonance signal includes adding the predetermined number of first resonance signals generated in the first loop processing of the predetermined number of sets corresponding to the predetermined number of first specific pitches and the one or more first resonance signals generated in the one or more first loop processing corresponding to the one or more second specific pitches to one another, and outputting the first resonance signal acquired by addition.

6. The resonance signal generating method according to claim 1, wherein
the excitation signal is a sound signal indicating musical performance sound of a piano, or a sound signal that is acquired by extraction of an attack from a sound signal indicating a musical performance of a piano.

7. The resonance signal generating method according to claim 1, further comprising:
generating a sound signal indicating a musical performance sound of a predetermined tone color in response to a detected musical performance operation;
supplying the generated sound signal to the first loop processing as the excitation signal; and
adding the generated sound signal and the first resonance signal to each other and outputs the added signal.

8. A resonance signal generating device comprising:
a first resonance signal generator that includes a first loop including a first delayer that delays a signal by a time corresponding to a specific pitch and a first attenuator that attenuates the signal, and an excitation inputter that inputs an excitation signal to the first loop;
a second resonance signal generator that includes a second loop including a second delayer that delays the signal by a time corresponding to the specific pitch and a second attenuator that attenuates the signal;
an inversion inputter that generates an attenuation change signal by adding a first resonance signal circulating through the first loop and a second resonance signal circulating through the second loop to each other, attenuating and inverting the added first and second resonance signals, and inputs the generated attenuation change signal to the first loop and the second loop; and
an outputter that outputs the first resonance signal circulating through the first loop.

9. The resonance signal generating device according to claim 8, wherein
the first resonance signal generator generates the first resonance signal circulating through the first loop by adding the signal attenuated by the first attenuator and the input excitation signal to each other, delaying the added signal by the first delayer, adding the signal delayed by the first delayer and the input attenuation change signal to each other, and attenuating the added signal by the first attenuator, and
the second resonance signal generator generates the second resonance signal circulating through the second loop by delaying the signal attenuated by the second attenuator by the second delayer, adding the signal delayed by the second delayer and the input attenuation change signal to each other, and attenuating the added signal by the second attenuator.

10. The resonance signal generating device according to claim 8, wherein
a delay amount of the first delayer is set such that a time required for one circulation of the signal in the first loop is equal to one period of sound of the specific pitch.

11. The resonance signal generating device according to claim 8, wherein
the first and second resonance signal generators include a plurality of sets of the first and second resonance signal generators respectively corresponding to a plurality of the different specific pitches, and generate a plurality of sets of the first and second resonance signals respectively corresponding to the plurality of specific pitches,
the inversion inputter generates attenuation change signals corresponding to specific pitches by adding the first and second resonance signals generated in each set of the first and second loops to each other, attenuating and inverting the added first and second resonance signals, and inputting a common attenuation change signal acquired by calculation of attenuation change signals corresponding to the plurality of specific pitches or the plurality of attenuation change signals corresponding to the plurality of specific pitches to the plurality of sets of the first and second loops respectively, and
the outputter adds the plurality of first resonance signals generated in the first loops of the plurality of sets and outputs the first resonance signal acquired by addition.

12. The resonance signal generating device according to claim 8, wherein
the specific pitch includes a predetermined number of different first specific pitches from a highest sound and one or more second specific pitches from a lowest sound,
the first and second resonance signal generators include the predetermined number of sets of the first and second resonance signal generators respectively corresponding to the predetermined number of first specific pitches and one or more first resonance signal generators corresponding to the one or more second specific pitches, generate the first and second resonance signals in the predetermined number of sets corresponding to the predetermined number of first specific pitches, and generates one or more first resonance signals corresponding to the one or more second specific pitches,
the inversion inputter generates the predetermined number of attenuation change signals corresponding to the predetermined number of first specific pitches by adding the first and second resonance signals in each set corresponding to the predetermined number of first specific pitches to each other, attenuating and inverting the added first and second resonance signals, and generates one or more attenuation change signals corresponding to the one or more second specific pitches by attenuating and inverting the one or more first resonance signals corresponding to the one or more second specific pitches, and respectively input a common attenuation change signal acquired by calculation of the predetermined number of attenuation change signals corresponding to the predetermined number of first specific pitches and the one or more attenuation change signals corresponding to the one or more second specific pitches, or the predetermined number of attenuation change signals corresponding to the predetermined number of first specific pitches and the one or more attenuation change signals corresponding to the one or more second specific pitches, to the predetermined number of sets of the first and second loops corresponding to the predetermined number of first specific pitches and the one or more first loops corresponding to the one or more second specific pitches, and
the outputter adds the predetermined number of first resonance signals generated in the first loops of the predetermined number of sets corresponding to the predetermined number of first specific pitches and the one or more first resonance signals generated in the one or more first loops corresponding to the one or more second specific pitches to one another, and outputs the first resonance signal acquired by addition.

13. The resonance signal generating device according to claim 8, wherein
the excitation signal is a sound signal indicating musical performance sound of a piano, or a sound signal that is acquired by extraction of an attack from a sound signal indicating a musical performance of a piano.

14. The resonance signal generating device according to claim 8, further comprising:
a sound signal generator that generates a sound signal indicating a musical performance sound of a predetermined tone color in response to a detected musical performance operation, wherein
the first resonance signal generator supplies the generated sound signal to the first loop as the excitation signal, and
the outputter adds the generated sound signal and the first resonance signal to each other and outputs the added signal.

15. An electronic musical apparatus comprising:
the resonance signal generating device according to claim 8;
a sound signal generator that generates a sound signal indicating a musical performance sound of a predetermined tone color in response to a detected musical performance operation;
a supplier that supplies the sound signal generated by the sound signal generator to the first loop of the resonance signal generating device as the excitation signal; and
a sound signal outputter that adds the sound signal generated by the sound signal generator and a sound signal output from an outputter of the resonance signal generating device to each other and outputs a sound signal acquired by addition.

16. A non-transitory computer readable medium storing a program allowing a computer to:
generate a first resonance signal of a specific pitch circulating through first loop processing by inputting an excitation signal to the first loop processing including first delay that delays the signal by a time corresponding to the specific pitch and first attenuation that attenuates the signal;
generate a second resonance signal of the specific pitch circulating through second loop processing by the second loop processing including second delay that delays the signal by a time corresponding to the specific pitch and second attenuation that attenuates the signal;
generate an attenuation change signal by adding the first and second resonance signals to each other, attenuating and inverting the added first and second resonance signals, and inputting the generated attenuation change signal to the first loop processing and the second loop processing respectively; and
output the first resonance signal.
